(19) United States
(12) Patent Application Publication
(10) Pub. No.: US 2006/0281449 A1
(43) Pub. Date: Dec. 14, 2006

(54) Enhanced call register menu

(76) Inventors: Huang Kun, Beijing (CN); Niu Xin, Beijing (CN); Li Wei, Beijing (CN); Nan Zhe, Beijing (CN)

Correspondence Address: PERMAN & GREEN, 425 POST ROAD, FAIRFIELD, CT, 06824, US

(21) Appl. No.: 11/152,828

(22) Filed: Jun. 14, 2005

(51) Int. Cl. H04M 3/00

(52) U.S. Cl. 455/418

(57) ABSTRACT

A method and system for accessing additional information associated with a number in a call register and establishing a communications connection using the additional information. A number is selected in the call register. A function associated with an icon indicating that additional contact information is available is activated. An extended sub-menu associated with the call register is displayed on a terminal of the device that displays selectable additional contact information associated with the selected contact. One of the additional contact information can them be selected. By activating an icon associated with the selected contact, one or more communication options for communicating with the contact are present and can be selected to establish a communications link.

### BACKGROUND OF THE INVENTION

1. Field of the Invention

The present invention relates to operating a user interface of a computer terminal, such as a mobile communication system and, more particularly, to a sub-menu system for ease of accessing contact information in a mobile communication device.

2. Brief Description of Related Developments

In a mobile telephone, users can generally locate “Missed Calls”, “Dialed Numbers” or “Received Calls” by activating a Call Log or Call Register menu of the phone. In this menu, the phone numbers are generally displayed in the order of the call, perhaps by time or date. If the number is matched with an entry in the memory of the device, the name or other stored information associated with the device is displayed in the call log or call register list. Generally, the user can activate a call register or call log menu function of the phone to check for missed calls, received calls or dialed numbers. Options related to the call log can include for example, the call time, send message, view number, edit number, save, add to contact, delete or call. However, if the user wants to check for other relevant contact information of a name stored in the call register, the user has to remember the name and then search in the phone book, which generally entails exiting the call register menu and accessing a address book, contact list, or other area where relevant contact information may be used.

A user can access a number saved in the call register and then dial,.redial or reconnect to that same number in order to try to contact the other party. This is essentially a “direct” dial or redial system. The number that the user of the phone missed, dialed or received, is the number (or name) stored in the register and the same one the user can redial, by pressing or activating the corresponding function (call or send, for example) of the phone.

However, in the event that the user wants to call or contact the other party, using a number other than the number that was missed, dialed or received, the user will have to exit the call log or register menu, and access another menu that contains the relevant contact information from which the user can choose new contact data. This process can involve a number of steps.

It would be helpful to allow a mobile phone user to be able to easily and directly locate and utilize additional phone numbers or contact information related to any entry in a call log or register, without having to search through or for other contact lists.

### SUMMARY OF THE INVENTION

The present invention is directed to a method of accessing additional contact information relevant to or associated with a call register or call log menu or function. In one embodiment, the method includes selecting a contact from one or more contacts in a call log menu. After selection of the desired contact, the user can access another menu associated with the contact that includes other relevant or associated contact information. The user can access the sub-menu by activating a function of the phone that corresponds to an icon or object associated with the selected contact. For example, if the sub-menu has a “right” arrow or pointer adjacent the contact name or number, the user would press the “right” movement button of the phone and the sub-menu with the additional contact information will be displayed.

The sub-menu will display other relevant contact information associated with the contact. This can include for example, other phone numbers or email addresses.

The user can then select the desired other contact information from the list and access another sub-menu of the phone that relates to the communication mode. The user can then select and activate the communication mode to call or communicate with the other party.

### BRIEF DESCRIPTION OF THE DRAWINGS

The foregoing aspects and other features of the present invention are explained in the following description, taken in connection with the accompanying drawings, wherein:

FIG. 1 illustrates a perspective front and rear view of one embodiment of a mobile terminal incorporating features of the present invention;

FIG. 2 is a block diagram illustrating one embodiment of an architecture of a mobile terminal that incorporates and can be used to practice, features of the present invention;

FIG. 3 is an illustration of a screen shot of one embodiment of a Call Log function menu of a mobile terminal communications system incorporating features of the present invention;

FIG. 4 is an illustration of a screen shot of an embodiment of a Missed Calls menu of a mobile terminal communications system incorporating features of the present invention;

FIGS. 5a-5d are illustrations of screen shots of embodiments of a menu structure in a communications system incorporating features of the present invention;

FIGS. 6a-6d are illustrations of screen shots of an embodiment of another menu structure in a communications system incorporating features of the present invention; and

FIG. 7 is a flow chart illustrating one embodiment of a method incorporating features of the present invention.

FIG. 8 is a block diagram of one embodiment of a typical architecture that can be used to practice the embodiments of the present invention.

### DETAILED DESCRIPTION OF THE PREFERRED EMBODIMENT(s)

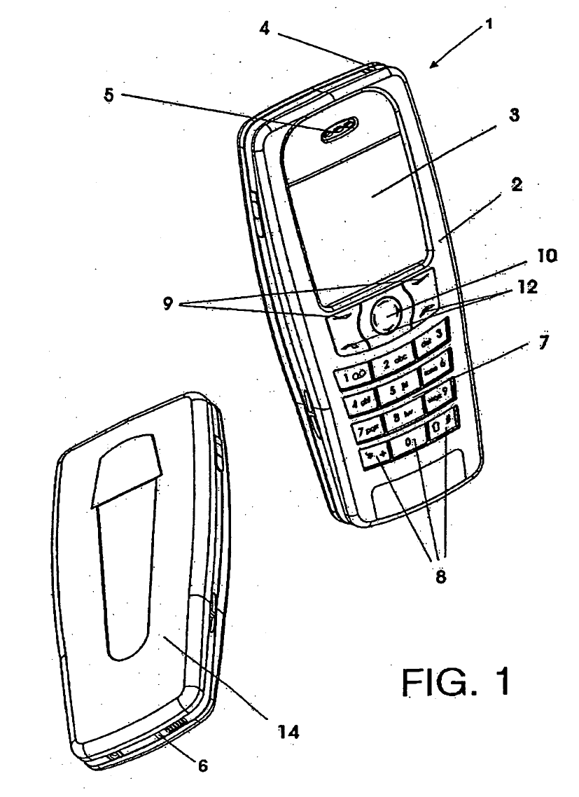

Referring to FIG. 1, a perspective view of a system 1 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

Referring to FIG. 1, a mobile communication terminal 1 according to the invention can generally be in the form of a handheld portable or cellular phone. In alternate embodiments, features of the invention can however also be carried out with any other computer or mobile terminal such as for example, a Personal Digital Assistant (PDA) or other device that can be used for mobile communications or messaging.

As shown in FIG. 1, the mobile phone 1 comprises a user interface having a housing 2, a display 3, an on/off button 4, a speaker 5 (only the openings are shown), and a microphone 6 (only the opening is shown). In one embodiment, the phone 1 is adapted for communication via a cellular network, such as the GSM 900/1800 MHz network, but could just as well be adapted for use with a Code Division Multiple Access (CDMA) network, a 3 G network, or a TCP/IP-based network to cover a possible VoIP-network (e.g. via WLAN, WIMAX or similar).

As shown in FIG. 1. the keypad of the phone 1 has a first group 7 of keys 8 as alphanumeric keys, by means of which the user can enter a telephone number, write a text message (SMS), write a name (associated with the phone number), etc. It should be noted that the keypad and arrangement of FIG. 1 is merely exemplary, and any suitable keypad and arrangement can be used to practice the embodiments of the present invention.

Each of the twelve alphanumeric keys 8 is provided with a figure “0-9” or a sign “#” or “*”, respectively. In alpha mode each key is associated with a number of letters and special signs used in the text editing. Generally, any suitable arrangement of keys, letters, symbols and signs can be used.

With reference to FIG. 1, the keypad additionally comprises a second group of keys comprising two soft-keys 9, two call handling keys 12, and a 5-way navigation key 10 (up, down, left right and center: select/activate). The functions of the soft-keys can depend on the state of the phone and navigation in the menu is performed by using the navigation-key. The present function of the softkeys 9 is shown in separate fields (soft labels) in the display 3, just above keys 9. The two call handling keys 12 are used for establishing a call or a conference call, terminating a call or rejecting an incoming call.

In one embodiment, the arrow key 10 can comprise for example, a five-way key which can be used for cursor movement, scrolling and selecting and is placed centrally on the front surface of the phone between the display 3 and the group of alphanumeric keys 7. A releasable rear cover 14 gives access to the battery pack that in the back of the phone supplies electrical power for the electronic components of the mobile phone.

In the example of FIG. 1 the mobile phone has a flat display 3 that is typically made of an LCD with optional back lighting, such as a TFT matrix capable of displaying color images.

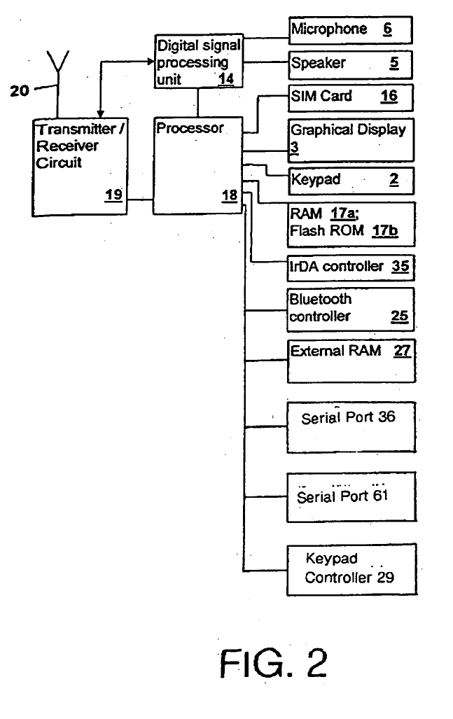

FIG. 2 illustrates in block diagram form on embodiment of a general architecture of a mobile terminal 1 of FIG. 1 that can be used to practice features of the present invention. A processor 18 controls the communication with the cellular network via the transmitter/receiver circuit 19 and an internal antenna 20. A microphones 6 transforms the user's speech into analog signals, the analog signals formed thereby are A/D converted in an A/D converter (not shown) before the speech is encoded in a digital signal processing unit 14 (DSP). The encoded speech signal is transferred to the processor 18, which e.g. supports the GSM terminal software. The processor 18 also forms the interface to the peripheral units of the apparatus which can include for example a RAM memory 17a and a Flash ROM memory 17b, a SIM card 16, the display 3, the IrDA controller 35, the Bluetooth controller 25, the serial port 36, 61 and the keypad controller 29, external RAM 27 and keypad 2 (as well as data, power supply, etc.). The digital signal-processing unit 14 speech-decodes the signal, which is transferred from the processor 18 to the speaker 5 via a D/A converter (not shown).

The present invention generally allows a user to more easily navigate through menus or screens of a mobile phone device in a simplified manner in order to access additional contact data or information related to a number (or other connection or contact data) stored in a call register function. This data can be accessed by the user without the need to leave a call register function to search in the phone book or contact list of the phone. It should be noted that although the term contact data or number is generally used in connection with describing the features of the present invention, the term contact number, information or data is meant to include any suitable form of connection information including for example, telephone numbers, cellular connection data and electronic mail addresses.

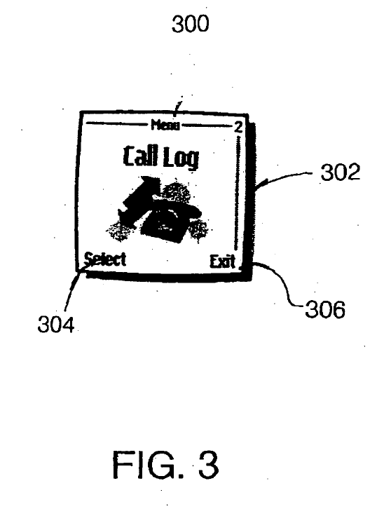

Referring to FIG. 3, a mobile phone or terminal incorporating features of the present invention will generally allow a user to access a “Call Log” menu 302 of the terminal. The call log can also be referred to as a call register. The user might enter the menu functions of the phone and navigate to the Call Log menu 302 function. The call log will log or store information about missed calls, received calls or dialed calls. These specific menus are generally accessed by activating a key or button of the phone that corresponds with the “Select” function 304 of the phone. For example, when the Call Log menu 302 is being displayed on the screen 3 of the phone 1 of FIG. 1, the left button 9 would allow the user to activate the “Select” function 304. Another screen would then be displayed on the phone that allows a user to access the “Missed Calls”, “Dialed Calls” or“Received Calls” menu. These procedures are generally known.

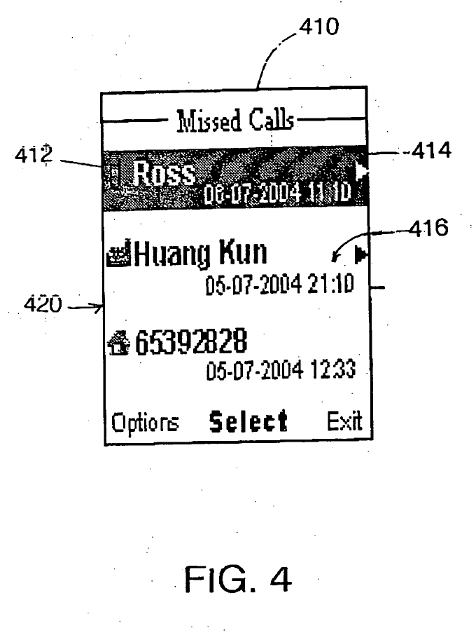

In order to access a Missed Calls menu of the device, the user will navigate through the screens and menus of the phone until they come to the Call Log menu 302. Using the Select function 304 they can navigate to a Missed Calls menu, such as that shown in FIG. 4, for example. For example, referring to FIG. 4, if the user wishes to view a missed call, the user goes to the missed call page 410 where a list 420 of missed calls will appear in the display. The user can then scroll to a name or number, such as Ross 12. It is generally known that if a number is matched with a memory entry in the phone book, then the name associated with the number is displayed in the call list 420. Generally, when a call is received, the identification of the calling number, or the number itself, will be compared to numbers stored in a memory of the phone. The memory could comprise a contact data folder or list, or a phone book of the phone, for example. In alternate embodiments the memory could comprise any suitable device or functionality of the terminal that stores contact information, such as for example, an address book. However, at this point, if the user desires to communicate with the person associated with the missed call, the user is limited to responding or calling via the same number that the calling party used to make the initial call. If the user desires to contact the missed call party 412, using another number that may be stored in the phone, the user must exit the missed call menu, and the call log menu, and search for example a contact list, address book, phone book or other memory storage area that stores contact information.

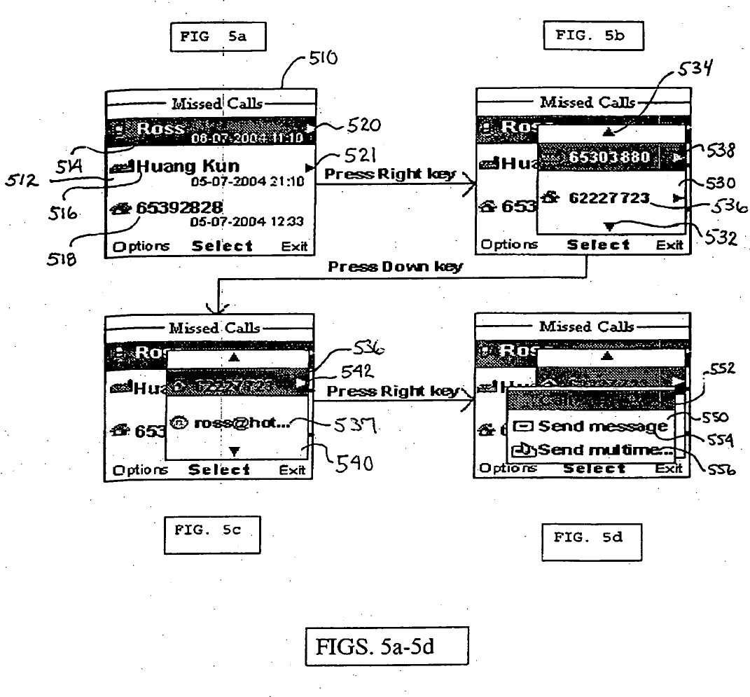

Referring to FIGS. 5a-5d, the user has accessed the Missed Calls menu 510 of the device. As shown in FIG. 5a, the Missed Calls 514, 516 and 518 are displayed on the screen of the phone. Using scroll options of the phone, the user may be able to scroll the screen to display other missed calls should any exist. As shown in FIG. 5a the missed calls are identified by a contact name, 514 and 516, or the phone number 518 of the party's phone of the call that was missed.

If the match has been found between the calling number and a number stored in the memory, contact information associated with the calling number is displayed in the call log. Thus, for example, the entry “Ross” 514 indicates that the calling number of that missed call matches a calling number that has been previously stored and is associated with the name Ross. The phone number entry 518 indicates that no match was found and no other information is stored or saved that is related to that particular calling number.

In FIG. 5a, the user has selected the Ross entry 514, as indicated by the highlighted bar. The arrow icon 520 pointing to the right indicates that more contact data is available. When the user access the right selection function, by for example pressing a right function key or cursor, the extended sub-menu 530 of FIG. 5b can be accessed. The extended sub-menu 530 displays additional information and contact data that is stored in memory. In the screen shot 53.0, two numbers are displayed “65303880” and “62227723”. As shown in FIG. 5b, the indication of up and down arrows 532, 534 on the screen 530 indicates that additional data and information that can be displayed. In alternate embodiments, the presence of additional data can be displayed in any suitable manner.

The user can manipulate a selection device to move between the entries 536, 538 shown in the extended sub-menu 530. For example, moving to FIG. 5c, the user has scrolled down the menu 530 and is now highlighting the number “62227723”. An additional contact information 540, the e-mail address “ross@hot...” is shown. When the selected entry 536 is highlighted, the user can manipulate the selection device in the direction of the arrow icon 542 to access a menu 550, shown in FIG. 5d, which presents the user with one or more options for communicating with the other party.

Moving to FIG. 5d, the user has activated the right arrow function 542 of FIG. 5c in order to display the connection alternatives or options for the number 536 “62227723”. As shown in FIG. 5d, these options can include for example, call 552, send message 554 or send multimedia 556.

Referring back to FIG. 5a, the “Missed Calls” menu 510 indicates that the User has missed a call of “Ross” 514. The user now wants to call “Ross” back, but does not want to call the same number that “Ross” had called from, which is stored in the Missed Calls list. The selection indicator 520 indicates to the user that other connection data is available for “Ross”. By using an appropriate key on the terminal, or other selection device, the user accesses the extended sub-menu of FIG. 5b, after highlighting or selecting Ross 514. The user moves to the extended sub-menu screen 530 and moves through the entries 536, 537 (FIG. 5c), 538 that are displayed to select the desired phone number or other contact information (such as an email address). The contact data for 537,is shown in FIG. 5c, but is part of the menu 530 shown in FIG. 5b. Once the user has selected the desired contact communication information 536 in FIG. 5c, the user activates the function or key 542 to select the menu page 550 of FIG. 5d that provides the user with the available communication options. As shown in FIG. 5c, a right arrow icon 542 is the pointer to the communication mode menu page 550. By activating a corresponding key on the phone, such as the right function key 9 of FIG. 1, the menu page 550 is displayed on the screen of the phone or terminal device. As shown in FIG. 5d, the communication modes that are made available to the user can include, for example, a call mode 552, a send message mode 554 and a send multimedia mode 556. The call mode 552 allows the user to establish a telephone call. The send message mode 554 allows the user to send a message. The send multimedia mode 556 allows the user to send a multimedia message. In alternate embodiments, the menu 550 can include any suitable types of communication modes. With the communication mode menu 550 being displayed, the user can navigate or scroll through the communication options 552-556 and select the desired communication function. Thus, by navigating from the initial missed calls menu 510 of FIG. 5a, to the additional contact information menu 530 of FIG. 5c, the user can find additional contact information related to a party in a direct and simplified manner. The user does not have to exit the call log function and find and enter a phone book or contact list function to locate and access the additional contact information.

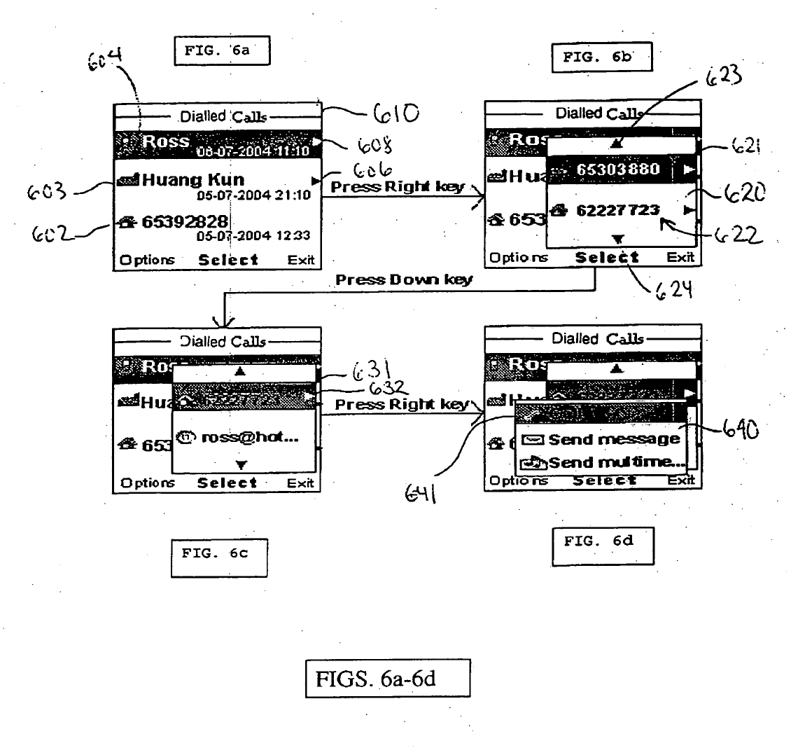

In a similar way, referring to FIGS. 6a-6d, the user has accessed the dialed calls menu 610 of a mobile terminal or phone. Here again, in prior systems, if the user finds the number or name of a party for which a number was previously dialed, in this example “Ross” 604. The user wishes to establish another communication session with that party, but using a different contact number or method. Previously, the user would have to exit the dialed calls function menu 610 and find and search a phone book or other similar function of the phone. In the present invention, referring to FIG. 6a, the user accesses the extended sub-menu 620 from the initial dialed calls menu 610 and obtains additional contact information, 621 and 622, associated with the dialed number 604 shown in FIG. 6a.

Referring to FIG. 6a, the user enters the dialed numbers menu 610. The numbers previously dialed (“Dialled Calls”) are displayed in a manner similar to those in the “Missed Calls” menu 510 of FIG. 5a. Dialed numbers that are matched with a memory entry in the phone book or contact list of the phone are displayed as names 602-604 in the dialed calls list 610. It is noted that the menu 610 may only be a partial view of the entire menu, being limited by the viewing area of the screen on which the menu 610 is displayed. In FIG. 6a, for example entries of “Ross” 604, “Huang Kun” 603 and the number “65392828” 602 are shown in menu 610. Since data associated with “Ross” 604 and “Huang Kun” 603 have been previously stored in the terminal, the names of the parties can be displayed rather than the phone number that was dialed. In alternate embodiments, any suitable identifying information or icon can be displayed. For example, although not shown, a graphical image or picture could be associated with a call listed in the menu 610. Both “Ross” 604 and “Huang Kun” 603 have a right arrow icon 608 and 606, respectively, that indicates that further contact information associated with the name or contact is available. By activating or selecting the right direction arrow 608 (using for example key input 10 of the phone of FIG. 1) the sub-menu page 620 of FIG. 6b becomes active and is displayed to the user.

Referring to FIG. 6a, the user navigates or scrolls the listing of “Dialed Calls” in the menu 610 and selects or highlights a desired dialed number, which, in the example of FIG. 6a, is “Ross” 604. In one embodiment, the last number dialed may be automatically highlighted, although any suitable arrangement can be used.

Since the highlighted contact 604 has further contact information associated with it, an indicator or icon. 608, such as for example a direction arrow, will indicate to the user to activate the corresponding selection key of the mobile device. After the contact 604 is highlighted, activating the “right” selection key 608 will cause the extended sub-menu 620 to be displayed as illustrated in FIG. 6b. The selection keys are those commonly known in the art; and can include fixed keys or 4-way scroll keys, for example.

Referring back to FIG. 6b, if the user wishes to locate other contact or connection data related to the contact 604, after entering the sub-menu 620, the user scrolls through the entries 622 in the extended sub-menu 620. The presence of icons or arrows 623 and 624 can be used to indicate the presence of additional information if the user scrolls in that direction. Once the desired entry is located, for example “62227723” 631 of FIG. 6c, the user can select or highlight that entry 631. A direction icon 632 indicates to the user to activate the corresponding selection key to proceed to the call options menu 640 of FIG. 6d, where the user can navigate through the menu options and select how to communicate with the contact 604. As shown in FIG. 6d, the option “Call” is selected and activation of the corresponding function key of the keypad on the terminal illustrated in FIG. 1 can activate or initiate a call to the selected number 631.

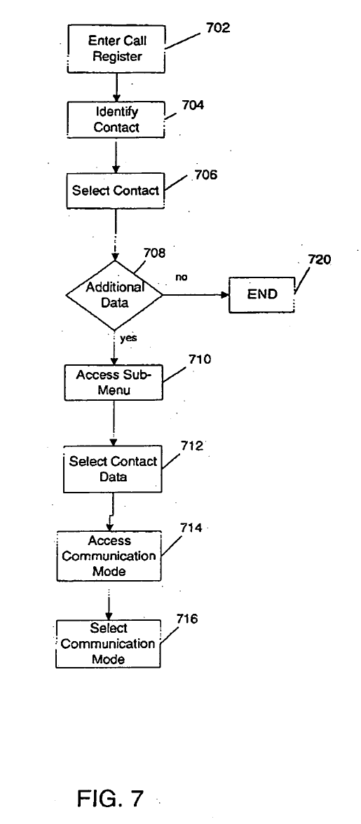

Referring to FIG. 7, a flowchart of one embodiment of a method incorporating features of the present invention is illustrated. The present invention is generally directed to simplifying locating additional contact information from a call register menu in a cellular phone. A user enters 702 the call log view of the phone to examine 704 the numbers associated with a call log or call register features of a communication device. The user selects 706 a desired number or name from the call log using a selection key. The user then determines 708 whether any additional contact information is available. An icon or pointer associated with the selected name, for example a right arrow, identifies that additional contact information is available upon activating a key of the terminal or phone corresponding to the arrow. Once in the extended submenu, the user can navigate through the list and highlight and select 712 a contact. Then, by activating a key corresponding to the communication mode function, the user can enter 714 the communication mode and establish a communications link.

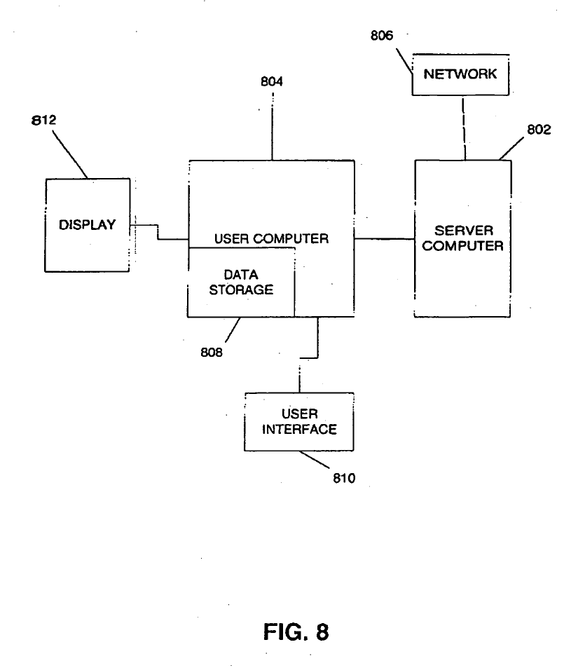

The present invention may also include software and computer programs incorporating the process steps and instructions described above that are executed in different computers. FIG. 8 is a block diagram of one embodiment of a typical apparatus that can be used to practice features of the disclosed embodiments. As shown, the terminal device of the present invention could include a computer system 804. Computer system 804 is generally adapted to utilize program storage devices embodying machine readable program source code which is adapted to cause the computer 804 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

In one embodiment computer system, or terminal 804, can be linked to another computer system 802, such that the computers 802 and 804 are capable of sending information to each other and receiving information from each other. In one embodiment, computer system 802 could include a server computer adapted to communicate with a network 806, such as for example, a cellular communication network. Computer systems 802 and 804 can be linked together in any conventional manner including a modem, hard wire connection, optical or fiber optic link. Generally, information can be made available to both computer systems 802 and 804 using a communication protocol typically sent over a communication channel or through a dial-up connection on ISDN line.

Computer system 804, and 802, may also include a microprocessor for executing stored programs. As shown in FIG. 8, computer 802 may include a data storage device 808 on its program storage device for the storage of information and data. The computer program or software incorporating the processes and method steps incorporating features of the present invention may be stored in one or more computers 804 (and 802) on an otherwise conventional program storage device. In one embodiment, computer 804 may include a user interface 810 and a display interface 812 from which features of the present invention can be accessed. In one embodiment the user interface 810 and display 812 can comprise a single display interface unit, such as for example a graphical user interface. The user interface 8810 and the display interface 812 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method for accessing additional communication information associated with a contact in a call register for establishing a communications connection comprising:
selecting a contact in the call register;
selecting an extended sub-menu associated with the selected contact;
displaying selectable “additional contact information associated with the selected contact;
selecting one of the additional contact information; and
selecting a communication option from a communications options menu for establishing a communications link with the contact using the additional contact information.

2. The method of claim 1 wherein the call register comprises a missed called log, a received call log and a dialed call log.

3. The method of claim 1 wherein the step of selecting a contact in the call register further comprises:
activating one of a plurality of call log functions of the phone;
displaying at least one contact related to the activated call log function; and
selecting a contact from the at least one contact in the activated call log.

4. The method of claim 1 wherein selecting an extended sub-menu comprises:
searching a memory device for additional contact information related to the selected contact;
identifying the additional contact information; and
displaying the additional contact information in a list.

5. The method of claim 1 further comprising using a first key input of the device to highlight the contact;
use a second key input of the device to activate the extended sub-menu;
use a third key input of the device to scroll a list in the extended sub-menu and highlight an additional contact information; and
use a fourth key input to activate a communications option list for communicating with the additional contact information.

6. The method of claim 1 further comprising, after selecting a contact in the call register, identifying if additional contact information related to the selected contact is available by a presence of an icon associated with the selected contact.

7. The method of claim 6 further comprising the icon identifying which key input is to be activated to select the extended menu associated with the selected contact.

8. A method for establishing a communications link with a contact from a call register of a communication terminal comprising:
selecting a name identifier in a call register menu;
determining if at least one additional contact information associated with the name identifier is stored in a memory of the communication terminal;
selecting an extended sub-menu function of the communication terminal if the at least one additional contact information is available;
selecting one of the at least one additional contact, information from the extended sub-menu; and
selecting a mode of communication to be used to communicate using the selected one of the at least one additional contact information.

9. The method of claim 8 wherein the step of selecting an extended sub-menu function further comprises:
activating a pointer on the call register menu to the extended sub-menu; and
presenting a top most sub-menu over the call register menu that includes a list of the at least one additional contact information and at least one pointer to a communication mode sub-menu.

10. The method of claim 9 further comprising:
activating the at least one pointer to a communication mode sub-menu;
presenting another top most sub-menu over the extended sub-menu that includes a list of at least one communication mode for communicating with a party of the name identifier using the selected one of the at least one additional contact information; and
where selection of one of the at least one communication mode from the list allows the user to communicate with the party.

11. A mobile communication system comprising:
first processing means for presenting a call register menu to the user, the call register menu including at least one data item that can be selected by the user;
second processing means for identifying that additional contact information is available for the selected data item;
third processing means for presenting a sub-menu to the user after selection of the sub-menu function associated with the selected data item, the sub-menu including additional contact information for the selected data item.

12. The mobile communication system of claim 11 wherein the mobile communication device comprises a mobile phone.

13. The mobile communication system of claim 11 further comprising a call-options sub-menu, the call-options sub-menu being displayed after selecting one of the additional contact information.

14. The mobile communications system of claim 11 wherein the second processing means further comprises a selectable icon that when activated, enables the sub-menu of additional contact information to de displayed, the sub-menu of additional contact information further comprising:
at least one selectable icon for indicating whether any further additional contact information is available to be displayed; and
a selectable icon associated with each additional contact information for activating a communications options system.

15. The mobile communications system of claim 14 wherein the communications options system further comprises a telephone connection system, an electronic messaging system or a multimedia messaging system.

16. A computer program product comprising:
a computer useable medium having computer readable code means embodied therein for causing a computer to access and connect to additional contact information with a contact in a call register, the computer readable code means in the computer program product comprising:
computer readable program code means for causing a computer to select a contact in the call register;
computer readable program code means for causing a computer to select an extended sub-menu associated with the selected contact;
computer readable program code means for causing a computer to display selectable additional contact information associated with the selected contact;
computer readable program code means for causing a computer to select one of the additional contact information; and
computer readable program code means for causing a computer to display and select at least one communication option for establishing a communication link with the contact.

17. An article of manufacture comprising:
a computer useable medium having computer readable program code means embodied therein for causing a computer to select contact information and connect with a contact using the contact information, the computer readable code means in the article of manufacture comprising:
computer readable program code means for causing a computer to select a contact identifier in a call register menu of a communication terminal;
computer readable program code means for causing a computer to determine if additional contact information associated with the contact is available;
computer readable program code means for causing a computer to display a sub-menu of additional contact information associated with the contact;
computer readable program code means for causing a computer to select one of the additional contact information;
computer readable program code means for causing a computer to display and select at least one communication option for establishing a communication connection with the contact using the additional contact information; and
computer readable program code means for causing a computer to establish a communications connection with the contact using the additional contact information.
